(19) United States
(12) Patent Application Publication
(10) Pub. No.: US 2010/0034968 A1
(43) Pub. Date: Feb. 11, 2010

(54) POLYMER COATING PROCESS USING DRY GLIDANT IN A ROTOR PROCESSOR

(75) Inventors: SHAWN M. ENGELS, TIPTON, IA (US); BRIAN K. JENSEN, CEDAR RAPIDS, IA (US)

Correspondence Address: MCKEE, VOORHEES & SEASE, P.L.C., 801 GRAND AVENUE, SUITE 3200, DES MOINES, IA, 50309-2721, US

(73) Assignee: VECTOR CORPORATION, MARION, IA (US)

(21) Appl. No.: 12/512,387

(22) Filed: Jul. 30, 2009

Related U.S. Application Data
(60) Provisional application No. 61/087,083, filed on Aug. 7, 2008.

(51) Int. Cl. B05D 7/00

(52) U.S. Cl. 427/212

(57) ABSTRACT

A method is provided for applying polymers to coat particulate cores in a rotor processor. The processor is actuated to create a circulating bed of cores in the rotor chamber. Dry powdered glidant is introduced into the rotating bed of cores, which are simultaneously sprayed with a polymer solution. The glidant enhances processability by eliminating or minimizing agglomeration of the cores. Air from above and below the rotating bed evaporates the solution to leave a polymer layer on the cores. Layers of polymer build up on the cores until a desired thickness is achieved.

### CROSS-REFERENCE TO RELATED APPLICATIONS

This application claims priority under 35 U.S.C. § 119 of a provisional application Ser. No. 61/087,083 filed Aug. 7, 2008, which application is hereby incorporated by reference in its entirety.

### FIELD OF THE INVENTION

This invention is directed towards a rotor process for coating or layering micronized particles with a polymer in a rotor processor. The polymer is generally from the methacrylate family of related polymers, including copolymers and monomers.

### BACKGROUND OF THE INVENTION

Coating or layering of small particulates, commonly known as cores, beads, crystals, pellets, granules or seeds, is well known for creating spherical particles, such as pharmaceuticals. The typical size for such particles is 50-10,000 microns. The coating material is normally a polymer, copolymer or monomer. A rotor processor is commonly used for such coating. This processor has a cylindrical stator chamber with a rotatable disc mounted therein, and a narrow annular slit between the inner wall of the stator and the perimeter edge of the rotor. The rotor forms a floor in the chamber upon which particles are supported. The width of the slit is sufficiently narrow so as to prevent particles in the chamber from falling through the slit. Rotation of the rotor imparts centrifugal force to the particles, which are thrown to the wall of the stator, wherein air forced upwardly through the slit lifts the particles upwardly. The width of the slit governs the air velocity for a given air flow, which creates an upward draft which carries the particles upwardly. The upward movement of the particles continues, as long as the air velocity exceeds the transport velocity required to circulate the particles. The air passing through the slit has a relatively high velocity, and then expands into the larger volume of the chamber, thereby losing velocity. As the particles lose their transport velocity, they fall back toward the center of the rotor and return to the rotor surface. Thus, the rotating rotor and the upwardly flowing air create a rotating bed of particles within the chamber.

The particles are coated or layered during circulation through the bed. In the conventional layering process, a polymer, copolymer or monomer is dissolved in a solvent, which is then sprayed onto the particles in the chamber while the particles are circulating. The airflow also functions to dry the solution on the cores, with the layer thickness being built up as the particles continue circulating through the bed for repeated exposure to the sprayed solution.

Coating and layering of particles in a rotor processor with solutions and dispersions of polymers is well known. These polymers can have an adhesive nature. In prior art coating processes, these polymers generally are diluted to 2-15% solids content to minimize agglomeration due to the adhesive nature. Furthermore, glidants are normally suspended in the polymer spray solution/dispersion so as to prevent or inhibit agglomeration during the coating process. Examples of glidants include titanium dioxide, calcium carbonate, magnesium stearate or any metal stearate, fumed or colloidal silica, sodium lauryl sulfate, graphite or any other finely divided material capable of reducing the adhesive nature of some polymers. Such glidants normally must be added to the polymer spray solution/dispersion in concentrations of 5-100%, based on the polymer solids in the solution/dispersion. These suspensions must be continuously agitated to prevent settling. The glidants in solution/dispersion often cause buildup in the spray guns, and thus blockage during processing, as well as problems with settlement in the solution/dispersion lines and other flow problems leading to inconsistent delivery during the coating process.

Therefore, a primary objective of the present invention is the provision of an improved method for applying coating material in a rotor processor using dry glidant powders.

Another objective of the present invention is the provision of a method of applying polymers to particulate cores in a rotor processor which overcomes the problems of the prior art.

A further objective of the present invention is the provision of a polymer coating process which eliminates the need to suspend glidants in the polymer solution.

Still another objective of the present invention is the provision of a method for applying polymer onto a rotating bed of cores in rotor processor while simultaneously introducing powder glidant to enhance processability.

Yet another objective of the present invention is the provision of an improved polymer coating process using a rotor processor having drying air supplied from both above and below the rotating bed of cores.

Another objective of the present invention is the provision of a polymer layering process in a rotor processor wherein the polymer is provided in solution at full strength, without dilution.

Another objective of the present invention is the provision of a method of applying polymers to a circulating bed of particulate cores which is efficient and economical.

These and other objectives will become apparent from the following description of the invention.

### SUMMARY OF THE INVENTION

In the polymer coating process of the present invention, the particulate cores are loaded into the rotor processor. The processor is actuated so as to rotate the rotor and to supply an upward air flow through the perimeter slit between the rotor edge and the cylinder wall, sufficient to keep particles from falling through the slit, but not sufficient to fluidize the bed. Dry glidant is introduced into the rotating or circulating bed of cores via the powder feed eductor, while simultaneously spraying the coating solution to form a polymer film on the circulating cores.

### DETAILED DESCRIPTION OF THE PREFERRED EMBODIMENT

The polymer layering process of the present invention is best suited for a rotor processor, such as the GX or GXR sold by Applicant, or a modified GX or GXR, which is described in co-pending patent application Ser. No. 12/509,513, filed on Jul. 27, 2009 and entitled IMPROVED ROTOR PROCESSOR FOR DRY POWDERS, which is incorporated herein by reference. Another example of a suitable rotor processor is that described in Applicant's co-pending application Ser. No. 11/669,544 filed on Jan. 31, 2007 and incorporated herein by reference. The rotor processor includes a stationary container or stator with a rotatable rotor mounted therein to define a rotor chamber. A drive assembly drivingly connects the rotor to a motor. The processor further includes one or more spray guns to introduce a wetting agent into the rotor chamber and one or powder feed systems to introduce the dry glidant powder into the rotor chamber. Preferably, the spray and powder ports are located in the stator wall adjacent the upper edge of the concave rotor at circumferentially spaced positions, so as to define separate spray and powder zones in the rotor chamber. Also, the powder feed system is connected to a pressurized air source so as to supply the powder at a positive pressure into the rotor chamber. A sample port may be provided in the processor, along with a window to observe the interior of the container during the layering operation. A product discharge port is provided in the stator to remove the finished, coated particles from the processor.

In the process of the present invention, the cores to be coated are loaded into the rotor chamber, and the processor is actuated to create a circulating bed for the particulate cores. The centrifugal force created by the rotating rotor and the air flowing upwardly through the gap between the outer perimeter edge of the rotor and the wall of the stator causes the particles to circulate upwardly adjacent the stator wall and downwardly along the central axis of the rotor chamber, while also keeping particles from falling below the slit. During this circulation, dry glidant is introduced into the rotating bed of cores via the powder feed system of the processor, while simultaneously spraying the coating solution to form a polymer film on the circulating cores. The particles pass repeatedly and sequentially through the spray and powder zones. The upwardly flowing air through the slit also functions to evaporate the solution, leaving a polymer layer on the cores. Additional drying air is introduced into the processor from above the bed, to further enhance evaporation. The delivery of a large amount of drying air from the top of the particle bed allows for rapid evaporation of the coating solution, while keeping the cores in contact with the rotor plate and maintaining the small gap between the rotor and the stator. As the circulation of the cores continues, the glidant powder and polymer solution forms a continuous polymer layer on the cores until a desired polymer layer thickness is achieved.

The following table provides a summary of various parameters for different types of Eudragit® polymers which have been used in coating tests. It is understood that these parameters may change for production scale coating.

| | | | Solids | Polymer | | | | | |
|---|---|---|---|---|---|---|---|---|---|
| | % Solids | Spray | addition | solids | Glidant | Airflow, | Exhaust | Total | % |
| Polymer | in | Rate | rate | Applied | Applied | Slit/Fluid | Temp | Time | Coating |
| Eudragit | solution | (g/min) | (g/min) | (g) | (g) | (CFM) | (° C.) | (min) | Applied |
| L-100 55 | 10 | 75.5 | 7.55 | 666 | 202.1 | 35/95 | 33-36° | 100 | 25 |
| L-100 | 10 | 78.6 | 7.86 | 666 | 195 | 35/95 | 31-37° | 95 | 25 |
| NE 40 D | 40 | 22.1 | 8.84 | 666 | 244 | 35/95 | 22-27° | 75 | 25 |
| L 30D 55 | 30 | 54.0 | 16.2 | 666 | 139 | 35/95 | 22-28° | 55 | 25 |
| EPO | 10 | 52.0 | 5.2 | 666 | 152 | 35/95 | 27-30° | 75 | 15 |

In tests, the glidant was fed at a very controlled rate, ranging from 0.1-1.0 grams of glidant per gram of polymer solid applied throughout the coating process. The process achieves virtually 0% agglomeration, without blockages or other problems in the spray gun and solution lines.

Preferred polymers for coating the cores are those from the methacrylate family of polymers, sold under the tradename Eudagrit® or those sold by BASF. Copolymers and monomers can also be used in the coating process of the present invention.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A method of applying a polymer coating to particulate cores in a rotor processor, comprising:
loading the cores into the processor;
rotating a rotor in the processor;
supplying air to flow upwardly through a slit between a perimeter edge of the rotor and a cylindrical wall of the rotor
whereby the rotating rotor and upwardly flowing air create a circulating bed of cores;
spraying a polymer solution/dispersion into the rotor chamber and onto the circulating cores to provide a polymer layer on the cores; and
introducing dry glidant into the rotor chamber to reduce agglomeration.

2. The method of claim 1 further comprising continuing the glidant application and polymer spraying until the polymer layer builds up to a desired thickness.

3. The method of claim 1 wherein the polymer is undiluted.

4. The method of claim 1 wherein the polymer is sprayed at full strength.

5. The method of claim 1 wherein the polymer and glidant are not pre-mixed.

6. The method of claim 1 wherein the glidant is introduced as a dry powder into the processor.

7. The method of claim 1 wherein the glidant and polymer solutions are introduced simultaneously into the processor from spaced apart locations.

8. The method of claim 1 further comprising supplying additional air into the processor from above the bed to facilitate evaporation of the solution on the cores.

9. The method of claim 1 wherein the glidant is applied at a rate of 0.1-1.0 grams per gram of polymer solid applied throughout the coating method.

10. The method of claim 1 wherein the polymer in solution is 2-60% by weight.

11. The method of claim 1 wherein the solution is sprayed at a rate of 1.5-50 grams of polymer solid per minute per kilogram of cores.

12. The method of claim 1 wherein agglomerations is substantially 0%.

13. An improved method of applying a polymer layer to particles in a rotor processor, comprising:
creating a rotating bed of particles in a rotor chamber of the processor;
spraying a polymer solution onto the particles in the rotor chamber; and
introducing dry glidant powder into the rotating bed to inhibit agglomeration.

14. The improved method of claim 13 wherein the glidant is introduced under positive air pressure.

15. The improved method of claim 14 further comprising passing the particles sequentially and repeatedly through separate spraying and coating zones in the rotor chamber to increase the layer thickness on the particles.

16. The improved method of claim 13 wherein the polymer is undiluted.

17. The improved method of claim 13 wherein the glidant is applied at a rate of 0.1-1.0 grams per gram of polymer solid applied throughout the coating method and the solution is sprayed at a rate of 2.5-50 grams of polymer solid per minute per kilogram of cores.

18. The improved method of claim 13 wherein the sprayed particles are substantially free from agglomeration.

19. The improved method of claim 13 wherein the polymer in solution is 2-60% by weight.

20. The improved method of claim 13 wherein air is supplied from above and below the bed to evaporate the solution and leave a polymer layer on the particles.
